(19) United States
(12) Patent Application Publication
(10) Pub. No.: US 2022/0181038 A1
(43) Pub. Date: Jun. 9, 2022

(54) SMART HOME WITH ARTIFICIAL INTELLIGENCE

(71) Applicant: DISH Network L.L.C., Englewood, CO (US)

(72) Inventor: Hakan Muhittin Karan, Colorado Springs, CO (US)

(73) Assignee: DISH Network L.L.C., Englewood, CO (US)

(21) Appl. No.: 17/114,755

(22) Filed: Dec. 8, 2020

(51) Int. Cl. G16Y 40/50; G16Y 40/10; G16Y 40/20; G16Y 20/40; G16Y 20/10

(52) U.S. Cl. CPC G16Y 40/50; G16Y 40/10; G06N 20/00; G16Y 20/40; G16Y 20/10; G16Y 40/20

(57) ABSTRACT

A system includes an activator, a sensor, and a hub, coupled thereto. The hub may include: a hub processor configured to execute non-transient computer instructions for instantiating a patterns engine, an exceptions engine, and a response engine. The patterns engine may include first computer instructions which configure the hub to define a pattern for a monitored person and generate a pattern message that may include the pattern. The exceptions engine may include second computer instructions which configure the hub to monitor the monitored person for a deviation from the pattern defined in the pattern message, and when the deviation may be identified, generate a deviation message. The response engine may include third computer instructions which configure the hub to generate, based on the deviation message, a response message. The response message may instruct the hub to activate as least one of the activator and the sensor.

### TECHNICAL FIELD

The technology described herein generally relates to systems for smart homes with artificial intelligence systems which facilitate providing of care and assistance to one or more persons.

### BACKGROUND

Human beings are typically creatures of habit. For example, most days, many persons awaken within a given window of time, proceed to attend to personal needs, have breakfast, and then go about that day's routines, such as going to work, shopping, playing scrabble, exercising, or otherwise. For elderly persons, children, handicapped persons, those suffering from various life threatening and/or debilitating illnesses, or the like (herein, an “assisted person”), knowing these routines, monitoring thereof, and detecting deviations therefrom can be helpful in facilitating alerting of others when an assisted person could use assistance.

Today, various mechanisms exist for alerting others when an assisted person needs assistance. Examples include emergency alert dongles which, when pressed by the assisted person, trigger an alarm message being sent to a monitoring company, heart-rate monitors, fall detectors, and other monitoring services, devices, and systems. These approaches, while often suitable for their limited purposes, are not limited as they often rely upon the assisted person taking an affirmative action, such as pressing a button on the dongle, or a given event happening, such as a person having an irregular heartbeat, falling, or otherwise. Many care instances for assisted persons may occur which do not fall within the gambit of currently available approaches. For example, a handicapped person might fall out of a wheelchair, while their dongle is not presently with them. Such a person may then have no or limited ability to seek assistance and may languish in such state for an indefinite period of time. Accordingly, devices, systems and methods for facilitating monitoring, detection, and alerting of others when an assisted person is in need of assistance are needed. The various implementations of the present disclosure address the above and other needs.

Likewise, persons not commonly needing assistance (herein, “non-assisted persons”) also commonly proceed through a given day's routine in a given order. While home automation devices and systems can be programmed to take specific actions, at specific times, areas of vast improvement are possible. Accordingly, needs exist for improved automation systems—needs which the various implementations of the present disclosure address.

### SUMMARY

The various implementations of the present disclosure describe devices, systems, and methods for facilitating smart homes with artificial intelligence. The various implementations also describe devices, systems, and methods for configuring home and other environments for assisted persons and non-assisted persons based upon detected, monitored, and determined user habits, tendencies, preferences, and the like.

At least one implementation of a system may include an activator; a sensor; and a hub, coupled to the activator and to the sensor. The hub may include: a hub processor configured to execute non-transient computer instructions for instantiating a patterns engine, an exceptions engine, and a response engine. The patterns engine further may include first computer instructions which configure the hub to define a pattern for a monitored person and generate a pattern message that may include the pattern. The exceptions engine further may include second computer instructions which configure the hub to monitor the monitored person for a deviation from the pattern defined in the pattern message, and when the deviation may be identified, generate a deviation message. The response engine further may include third computer instructions which configure the hub to generate, based on the deviation message, a response message. The response message may instruct the hub to activate as least one of the activator and the sensor.

An implementation feature may include a response message that further instructs the hub to notify at least one of a point of contact and a responder of the pattern and the deviation from the pattern. The activator may include a self-monitoring analysis and reporting technology (SMART) home device. The sensor may include a SMART home sensor.

The first computer instructions may further configure the hub to define the pattern based upon at least one parameter. The at least one parameter may be obtained from at least one of a user input, the sensor, and a database. The user input may be provided by at least one of the monitored person, a point of contact and a responder. The database may be at least one of a user profile database, a house database, a response database, and a network element database. The pattern may include at least one daily pattern. The daily pattern may be a routine of the monitored person that may be scheduled to occur on a given day, and at least one of at a given time and within a given time period.

The first computer instructions may include instructions for instantiating an artificial intelligence process executed by hub processor. The artificial intelligence process may facilitate defining of a predicted future pattern for the monitored person based upon a currently active pattern and at least one of a prior daily pattern, a current event, a current activity, a future event, and a future activity. The current event may include a weather event. The artificial intelligence process may update the currently active pattern to reflect predicted conditions arising due to the weather event.

The user device may include at least one detector. The at least one detector may include at least one of a user location detector, a user motion detector, a user biometric detector, and a user environmental detector. The user device may output, to the hub, user data generated by the at least one detector, The exception engine may identify deviation based upon the user data received from the user device. The response engine may communicate the response message to the at least one network element. The response message may identify the pattern, the deviation from the pattern, and the activation of the at least one of the activator and the sensor. The at least one network element further may include at least one of a point of contact device associated with a designated point of contact person, and a responder device.

At least one implementation of the present disclosure may include a hub. The hub may include a hub processor configured to execute non-transient computer instructions for instantiating a patterns engine, an exceptions engine, and a response engine. The hub may include a storage device 110, coupled to the hub processor, configured to store non-transient data in at least one of a user profile database, a house database, and a response database. The patterns engine further may include first computer instructions which configure the hub to define a pattern for a monitored person and generate a pattern message that may include the pattern. The exceptions engine further may include second computer instructions which configure the hub to monitor the monitored person for a deviation from the pattern defined in the pattern message, and when the deviation may be identified, generate a deviation message. The response engine further may include third computer instructions which configure the hub to generate, based on the deviation message, a response message; and where the response message instructs the hub to activate as least one of an activator and a sensor.

An implementation feature may include a hub to user device interface operable for receiving user data from a user device. The user data may include data provided by at least one of a user location detector, a user motion detector, a user biometric detector, and a user environmental detector. The deviation may be identified by the exceptions engine based upon the user data received from the user device.

At least one implementation of a method of the present disclosure may include operations including initializing a monitored person; generating a daily pattern for the monitored person, actively monitoring the monitored person for a deviation from the daily pattern, and generating a response when the deviation may be detected.

An implementation feature of the initializing of the monitored person further may include: first generating a user profile based upon data obtained from a user profile database associated with a hub device utilized in the actively monitoring of the monitored person; and second generating a user profile based upon data obtained from at least one of a medical database, a work database, criminal database, and a database provided by a network element. The user profile database may include at least one user preference. The at least one user preference may include an advance medical directive.

The actively monitoring of a monitored person for a deviation from the daily pattern further may include: receiving sensor data from a first sensor; and determining whether the sensor data conforms with the daily pattern for a given time of a given day. When the sensor data does not conform with the daily pattern, the active monitoring may include generating a deviation message indicating the daily pattern and the deviation from the daily pattern; and outputting the deviation message to a response engine being executed by a processor in a hub device. The response message may identify the daily pattern and the deviation. The response message may activate at least one of an activator and a sensor. The response message may communicate the daily pattern and the deviation from the daily pattern to at least one of a point of contact device and a responder device.

### BRIEF DESCRIPTION OF THE DRAWINGS

The features, aspects, advantages, functions, modules, and components of the devices, systems and processes provided by the various implementations of the present disclosure are further disclosed herein regarding at least one of the following descriptions and accompanying drawing figures. In the appended figures, similar components or elements of the same type may have the same reference number and may include an additional alphabetic designator, such as 108a-108n, and the like, wherein the alphabetic designator indicates that the components bearing the same reference number, e.g., 108, share common properties and/or characteristics. Further, various views of a component may be distinguished by a first reference label followed by a dash and a second reference label, wherein the second reference label is used for purposes of this description to designate a view of the component. When the first reference label is used in the specification, the description is applicable to any of the similar components and/or views having the same first reference number irrespective of any additional alphabetic designators or second reference labels, if any.

FIG. 1 is a schematic illustration of a system for facilitating a smart home with artificial intelligence and in accordance with at least one implementation of the present disclosure.

FIG. 2 is a flow diagram illustrating a method for smart home with artificial intelligence provided in accordance with at least one implementation of the present disclosure.

### DETAILED DESCRIPTION

The various implementations of the present disclosure describe devices, systems, and processes for facilitating detection, monitoring, and alerting others of needs of assisted persons. The various implementations also describe devices, systems, and processes for facilitating the detecting, monitoring, and configuring of homes, vehicles, and other environments for assisted persons and non-assisted persons based upon detected, monitored, and determined user profiles. As used herein, assisted persons and non-assisted persons are commonly identified as being a “monitored person”.

System 100

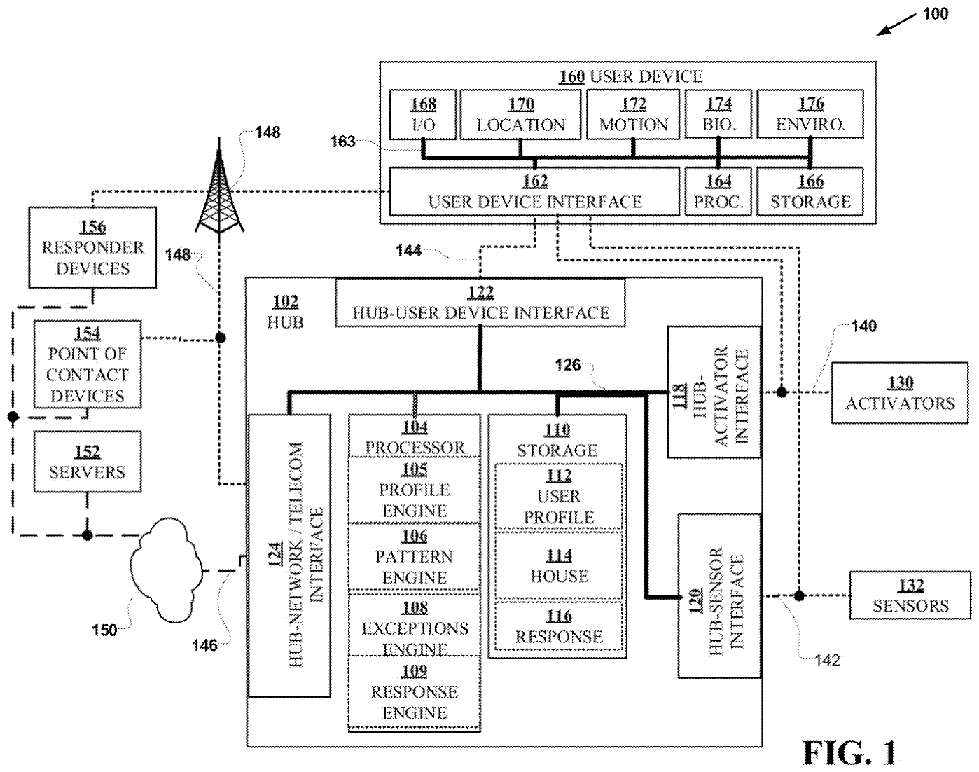

As shown in FIG. 1, a system 100 may include a hub 102 coupled to one or more activators 130, one or more sensors 132, one or more user devices 160, and, for at least one implementation, to one or more “network elements”, such as servers 152, point of contact devices 154, responder devices 156, or otherwise. For at least one implementation, the system 100 may be stand-alone and instantiated using or not using one or more network elements. As used herein, a device, system, component, or combination thereof that is coupled to a given hub 102 is referred to, individually and collectively, as an “external device.” A hub 102 may be provided for use with any given one or more definable areas, such as a home, garage, office, car, recreational vehicle, shed, patio, hangar, yard, courtyard, common hallway (as in a multiple unit dwelling), elevator, driveway, boathouse, swimming pool area, or the like. As used herein, any such one or more definable areas in which a system 100 is used, for a given implementation, is identified as a “home.”

Hub 102

The hub 102 may include various components common to computing devices today, and various other components provided pursuant to the present disclosure. Common components may include a processor 104, a storage device 110, one or more interfaces to external devices, such as a hub to activator interface 118, a hub to sensor interface 120, a hub to user device interface 122, a hub to network/telecom interface 124, and a bus 126 coupling two or more of the hub 102 components together.

Other common components (not shown in FIG. 1) may include power modules, user input/output modules, security modules (both physical and virtual), and the like. Any known or later arising technologies may be used for such common components. Many of these components are further described below.

More specifically, the hub 102 may be further configured, for at least one implementation, to include a power module (not shown). The power module may include any known or later arising technologies which facilitate the use of electrical energy by the hub 102. Non-limiting examples of such technologies include batteries, power converters, inductive charging components, line-power components, solar power components, and otherwise.

The hub 102 may include any known or later arising human to device interface components, processes, and technologies. Non-limiting examples of input/output uses include audible inputs (such as spoken commands) and outputs (generated sound), visible inputs (such as eye tracking and facial recognition) and outputs (such as visible images presented on a display device, LEDs, or otherwise), touch inputs touch feedback (such as vibrations or other movements), gesture tracking, and otherwise. The hub 102 may be coupled to and/or include the one or more presentation devices (not shown). The presentation devices facilitate interactions between an operator and the hub 102.

The hub 102 may include a security module (not shown). The security module may include any known or later arising security hardware components and/or computer instructions configured for use to secure data, communications regarding such data, hub processes and data, and otherwise. Security components may be used to facilitate secure transmission, processing, storage and otherwise of any data used in accordance with an implementation of the present disclosure.

Non-common components may include one or more computer hardware/software executed engines (as further described below) such as a profile engine 105, a pattern engine 106, an exceptions engine 108, and a response engine 109. It is to be appreciated that an engine is instantiated by a hardware processor executing non-transient computer instructions (as defined below) to perform one or more data processing, input/output, communications, control, or other tasks and activities. Other engines may be used in implementations of the present disclosure.

Other non-common components may include one or more databases provided by and/or under the direction and/or control of the storage device 110. Non-limiting examples of such databases may include a user profile database 112, a house database 114, and a response database 116. Other databases may be used for a given implementation of the present disclosure.

It is to be appreciated that a hub 102 may be realized using any known or later arising computing device technologies. Non-limiting examples of computing devices that may be used, in whole or in part, as a hub 102 include desktop computers, laptop computers, tablet computing devices, servers, data storage modules, smartphones, gaming systems, cable/satellite set top boxes, Internet streaming devices, 10-Foot devices, network routers, smart home controllers, whole-home control devices, audio/video processors, home alarm systems, and the like.

Hub: Processor 104

As referenced above, a hub 102 may include a processor 104. For at least one implementation, such processor 104 may include a physical/hardware processor. For other implementations, the processor 104 may be instantiated as a virtual machine processor, or otherwise. The processor 104 may include a server central processing unit (CPU) or similar electrical data processing device. Any known or later arising CPU may be used. The processor 104 may be provided by any local processing device capable of executing one more non-transient computer executable instructions (herein, a “computer instruction”) which, in accordance with an implementation of the present disclosure, facilitates one or more data processing operations including, and not limited to, the pattern engine 106, the exceptions engine 108, and the response engine 109.

The processor 104 may include one or more components configured for data processing operations. For at least one implementation, the processor 104 may include one or more hardware processors, such as 32-bit and 64-bit central processing units, multi-core ARM based processors, microprocessors, microcontrollers, and otherwise. The computer instructions may include instructions for executing one or more applications, engines, and/or processes configured to perform computer executable operations. Such hardware and computer instructions may arise in any given computing configuration including, and not limited to, local, remote, distributed, blade, virtual, or other configurations and/or systems configured for use in support of the one or more implementations of the present disclosure. Any known or later arising technologies may be utilized in conjunction with an implementation of the present disclosure to facilitate the processor 104, the pattern engine 106 and the exceptions engine 108.

The processor 104 may be communicatively coupled, by the bus 126 or similar structure, to other components of the server including, and not limited to, a storage device 1104, which may also be referred to as a “computer readable storage medium.”

As used herein, an “engine” refers to at least one of a dedicated hardware, such as an application specific integrated circuit (an “ASIC”), a combination of hardware with specially purposed computer instructions, a combination of general purpose hardware, such as a CPU and non-volatile computer to perform certain data processing operations, and the like. It is to be appreciated that such engines may be provided separately, collectively, or otherwise by one or more correspondingly configured physical devices, systems, and/or collection of devices and systems, including, and not limited to, those provided using a distributed system or otherwise. The hub 102 may be any computing device capable of facilitating one or more of the operations described herein, and/or otherwise provided by an implementation of the present disclosure.

Hub: Processor: Profile Engine 105

A profile engine 105 may be instantiated by the processor 104. The profile engine 105 may be configured to perform computer instructions which generate a characterization (herein, a “profile”) of a monitored person. Such profile may be generated based upon user profile information obtained from a user profile database 112 (as described further below), from network elements, or otherwise. Non-limiting examples of information provided in a generated profile may include height, weight, ethnicity, allergies, likes, dislikes, and the like.

Hub: Processor: Pattern Engine 106

A pattern engine 106 may be instantiated by the processor 104. The pattern engine 106 may be configured to perform computer instructions which determine, define, allocate, specify, or otherwise identify (herein collectively, “define”) a pattern for one or more monitored persons. As used herein for at least one implementation, a “pattern” is a sequence of activities (or inactivity's—such as sleeping) which a given monitored person is likely to perform, in view over a given time period. The given time period may be designated in any increment, such as hourly, daily, weekly, yearly, or otherwise. A “daily pattern” refers to a routine of a monitored person that is scheduled or calendared for the monitored person on a given day, at a given time, within a given time window, or the like. A non-limiting example of a first daily pattern is a timing of a person's taking of one or more medications in the morning and while a second daily pattern may include a timing of taking a second medication in the evening. A daily pattern may be provided, scheduled determined, or otherwise obtained by and from any source, such as a calendaring application like MICROSOFT OUTLOOK or otherwise. A pattern may include one or more daily patterns. The pattern engine 106 may generate one or more “pattern messages” that the exceptions engine and/or the response engine 109 may act upon accordingly. A pattern message may identify one more actions a monitored person will perform and/or activations which an activator may be instructed to perform to facilitate one or more daily patterns. For example, a pattern message may provide that the given monitored person typically drinks coffees at 6 A.M. and includes an identification that the coffee maker is to be activated at 5:50 A.M. to provide the coffee.

A daily pattern may vary day-by-day, by day of a week, by time of year, by location, and otherwise. For example, a daily pattern may be common for Monday through Friday, different for Saturday and further different for Sunday. Similarly, a daily pattern may vary based upon whether a monitored person is at their primary home, at a second home, at a hotel, or otherwise.

Daily patterns may include any level of specificity. For example, a daily pattern may define a given window in which the monitored person awakens, whether the monitored person consumes coffee before brushing their teeth or taking medications, whether the monitored person prefers to read an online edition of a newspaper while consuming their morning coffee, how long the monitored person typically spends in a bathroom showering, bathing and/or attending to other tasks, and the like. It is to be appreciated that a given daily pattern may be common to one or more persons, unique to a given person, or otherwise. A common daily pattern may arise, for example, in a structured home environment, such as a prison, senior living facility, day care, adult day care, home where children are present, or otherwise. For a likely majority of uses of an implementation of the present disclosure, it is anticipated that a daily pattern may be unique to a given monitored person, a given collection of monitored persons (such as between two spouses), a given household (such as one having adult and non-adult members), and otherwise. Common daily patterns may be used.

For at least one implementation, the pattern engine 106 may be configured to define a daily pattern for a monitored person based upon one or more parameters. Such parameters may be inputted manually, provided semi-automatically (such as by OUTLOOK), and/or automatically provided to the hub 102 and the pattern engine 106 by an external source, for example, an airline ticketing service providing parameters for a scheduled flight.

For at least one implementation, the pattern engine 106 may be configured to define a daily pattern based upon traveler information populated in one or more frequent traveler databases and/or patterns of behavior for a given user. Non-limiting examples of such traveler information include hotel memberships including preferred hotels and room/accommodation preferences; airline preferences including frequent flyer programs, memberships, status, and seating preferences; ground transportation preferences including bike, car rental, rickshaw, rideshare, scooter, taxi, and other preferences; travel schedules including airline, train, ferry and other schedules, and the like. Such traveler information may be stored in any suitable database including the hub 102 storage device 110, the user device 160 storage device 166, at a storage device provided by a network element such as server 152, or otherwise.

Parameters may be obtained from one or more databases including, and not limited to, a user profile database 112, a house database 114, a response database 116, or other databases. Such databases may be provided in whole, in part, or otherwise by the hub 102, a network element, a user device 160, or otherwise.

A daily pattern may be generated based upon past behavior and/or in view of future behavior. For example, a monitored person may go to bed and awaken at routine times. Such times may be input by, determined by a sensor or otherwise associated with a given monitored person as a parameter for such monitored person. Parameters may also be input by another person, such as family member, a caregiver, or otherwise, determined based upon actions or inactions of others, and otherwise. It is to be appreciated, that the pattern engine 106 may include parameters specified at any level of frequency (including one-off parameters), repetition (e.g., daily, weekly, hourly, or the like), specificity, or otherwise. For example, daily patterns may be specified for mornings, mid-day, afternoon, dinner time, evening, and while sleeping.

For at least one implementation, a pattern message may be generated and presented to a given user based upon an upcoming event. For example and not by limitation, a daily pattern identifying a user going on a trip overnight may include a pattern message that identifies one or more items that user will likely need (or may have to include) on the trip—examples include toiletries, medications, specific clothing (if as needed, for example, winter clothing for a person residing in an tropical climate scheduled to travel to a polar climate), currencies, electrical power converters/adaptors, and the like. For at least one implementation, such items may be presented to the user using a suitable activator, such as a television or display monitor, a SMART mirror, as a smartphone reminder, as one or more text messages, in an email, or otherwise. Exception messages (as discussed below) may be generated and communicated to the user when one or more items are not suitably packed or the like for a trip.

For at least one implementation, a pattern message may include identifications of specific daily pattern activities, such as wake-up times, travel directions (e.g., to/from an Airport), and the like. The system 100 may be configured such that pattern message communicated to a user device 160 may be provided to a second device, for example and not by limitation, an intra-car infotainment/navigation/display system, a GPS device, or otherwise.

For at least one implementation, daily patterns may be learned by the pattern engine 106 based upon one or more of user inputs, sensor detected events, use(s) of an activator 130, and otherwise. More specifically, the processor 104 may be configured to receive data from one or more sensors 132 and activators (herein, such data respectively being “sensor data” and “activator data”). Based upon such received sensor data and/or activator data, the pattern engine 106 may be configured to define a pattern for the monitored person. The pattern engine 106 may be further configured to update, adjust, or otherwise redefine (herein collectively, “update”) a pattern for a given monitored person based upon sensor data and activator data. Such updates to a pattern may occur at any time, including real-time, substantially real-time, after a delay, or otherwise. For example, a non-movement of a monitored person, as detected based upon sensor data from one or more sensors, may result in a daily pattern being updated to reflect that the monitored person takes a nap (or is otherwise inactive) during a given period.

For at least one implementation, daily patterns may be predicted by the pattern engine 106, such predicted patterns being referred to herein as a “predicted future pattern”. The processor 104 may be configured to include artificial intelligence, machine learning, and other data processing capabilities that are operable to generated the predicted future pattern based upon a currently active pattern and in view of at least one of a prior daily pattern, a current event, a current activity, a future event, and a future activity. For example, a past daily pattern may inform the pattern engine 106 that a monitored person typically sleeps for eight (8) hours a night, while typically laying down to sleep at 10 p.m. When the monitored person is up late, for example attending a concert or show, and does not lay down until 11 p.m. to sleep, the pattern engine 106 may be configured to adjust a daily pattern for the next day accordingly. For another example, the pattern engine 106 may be configured to update a daily pattern based upon external events, such as a weather event. For example, a daily pattern may be updated to reflect an earlier awakening time is needed when a monitored person is to travel to work under inclement weather conditions. Similarly, a daily pattern may be updated to reflect that a monitored person who typically takes a walk at a given time of day should use galoshes versus tennis shoes, when inclement weather is occurring or likely to occur during the walk.

It is to be appreciated that the pattern engine 106 may be configured to use any known or later arising technologies which facilitate pattern defining, in advance, real-time or otherwise, for one or more monitored persons, and at any given level of specificity.

For at least one implementation, the system 100 may be configured to configure one or more activators 130 based upon a user's location vis-a-vis a given destination. For example and not by limitation, while the user approaches their home, an alarm system may be deactivated, a garage door opened, interior lights activated, coffee brewed and the like—as based upon one or more patterns or daily patterns and as based upon sensor data, such as location data provided by a GPS sensor or the like.

Hub: Processor: Exceptions Engine 108

An exceptions engine 108 may be instantiated by the processor 104. The exceptions engine 108 may be configured to perform computer instructions which detect, anticipate, or otherwise identify (herein, collectively, “identify”) a deviation from a given daily pattern for one or more monitored persons, as such daily pattern is specified in a pattern message. The exceptions engine 108 may be configured to generate an “exception message” that is in response to an actual and/or potential deviation such that harm to person and/or property is prevented, reduced, minimized, or otherwise addressed (if addressable). The exception message may be communicated to the user or others.

For at least one implementation, the exceptions engine 108 may be configured to monitor actual and/or potential deviations in view of at least three deviation categories—the probability or “exposure” of the deviation occurring, the “severity” of the deviation if it occurs/is occurring, and whether the deviation, should it occur, is “controllable.” The parameters may range from high too low for a deviation category, with “high” generally designating a more critical deviation. The exception message may include ratings of one or more of exposure, severity, and controllability for a given one or more identified actual and/or potential deviations.

For example and not by limitation, a monitored person falling off a building is one that has a high exposure rating should such a monitored person proceed onto a roof surface. The severity rating of a fall from the roof may be high, especially if the ground below is concrete, versus low if the fall is into a sufficiently deep swimming pool, and the controllability is high if interventions are made before the monitored person enters onto the roof, and low when the monitored person is at roof edge. For a similar non-limiting example, a monitored person who has fallen in their bathroom (for example) may trigger an identification of a deviation by the exceptions engine 108 based upon one or more an exposure, severity, and controllability rating. The exceptions engine 108 may be configured to identify actual and/or potential deviations and generate and output an exception message to the response engine 109.

Hub: Processor: Response Engine 109

A response engine 109 may be instantiated by the processor 104. The response engine 109 may be configured to receive the pattern message and any exception message. With respect to the pattern message, the response engine 109 may be configured to proactively activate and/or operate one or more activators and/or sensors. For example, turning on dimmed lights prior to the monitored person typically awakening and increasing the brightness of such lights as the monitored person arises. With respect to exception messages, the response engine 109 may be configured to determine which pattern message(s) (or portion thereof) are then operable—such information identifying a then arising status or condition of a given home (such as whether the lights are on or off in a given area), identify the exposure, severity and controllability of the identified deviation from a given pattern, and in view thereof generate and output a “response message” to one or more of the user, network elements, and/or external devices, such as activators 130 and sensors 132. The response message may instruct a user to take/refrain from certain actions, instruct activators 130 and/or sensors 132 to perform specific tasks or activities, and may provide data to network elements which facilitate a response by one or more of a point of contact, such as a family member, and/or a responder, such as a first responder. It is to be appreciated that the response message may vary based upon the relevant daily pattern active at a given time, and the information provided in the exception message.

For example and not by limitation, a person falling off their roof may generate a response message which informs first responders to proceed without delay to the location at which the deviation was identified. Similarly, an exception indicating that a person has not stirred from their bed, may result in an action which monitors their physical condition (e.g., are they breathing) and/or may result in a catalyst which influences a change in their physical, mental or other condition (e.g., by brightening a room, increasing volume of a television, or otherwise). It is to be appreciated that a given response message may be common with or unique from any other given response message.

Hub: Storage Device 110

The hub 102 may include a storage device 110. The storage device 110 may be a single storage device, multiple storage devices, or otherwise. The storage device 110 may be configured to store user profile data in a user profile database 112, house data in a house database 114, respond data in a response database 116, and other data. The storage device 110 may be provided locally with the hub 102 or remotely, such as by a data storage service provided on the Cloud, and/or otherwise. Storage of data, including, and not limited to, user profile data, house data, response data, and other data may be managed by a storage controller (not shown) or similar component. It is to be appreciated such a storage controller manages the storing of data and may be instantiated in one or more of the storage device 110, on/with the processor 104, on the Cloud, or otherwise. Any known or later arising storage technologies may be utilized in conjunction with an implementation of the present disclosure to facilitate the storage device 110.

Available storage provided by the storage device 110 may be partitioned or otherwise designated by the storage controller as providing for permanent storage and temporary storage. Non-transient data, computer instructions, or other the like may be suitably stored in the storage device 110. As used herein, permanent storage is distinguished from temporary storage, with the latter providing a location for temporarily storing data, variables, or other instructions used for a then arising data processing operations. A non-limiting example of a temporary storage device is a memory component provided with and/or embedded onto the processor 104. Accordingly, it is to be appreciated that a reference herein to “temporary storage” is not to be interpreted as being a reference to transient storage of data. Permanent storage and/or temporary storage may be used to store either, if not both, transient and non-transient computer instructions, and other data.

Hub: Storage: User Profile Database 112

As discussed above, the storage device 110 may include a user profile database 112. The user profile database 112 may include any data regarding a monitored person. Non-limiting examples of such data include demographic, psychographic, medical, personal, preferences of the monitored person, and other data. The user profile data may be used by one or more of the pattern engine, the exceptions engine and the response engine. For example, user profile data identifying a monitored person has being elderly and on heart medication may be used by the pattern engine to facilitate the generation of a daily pattern that include heart healthy activities, such as taking walks, checking their blood pressure periodically, taking medications, or the like. The user profile database 112 may include care instructions, including, and not limited to, identifying others with medical powers of attorney, living will conditions, advanced directives, and the like. Further, such user profile data may be used by the exceptions engine in identifying deviations from a daily pattern and/or real-world events, such as the monitored person not awakening, their blood pressure being abnormally high, or the like. Further, the user profile data may be used by the response engine to generate response messages which inform a first responder of the monitored person's current medical status, medications, allergies, drug interactions to avoid, and the like.

Hub: Storage: House Database 114

As discussed above, the storage device 110 may include a house database 114. The house database 114 may include any data regarding a home at which a monitored person is currently located or will, at some time in the future, be located. Non-limiting examples of house data include floor plans, egress/ingress locations, locations of circuit breaker panels, alarm locations, sensor locations, activator locations, and any other information collected and/or collectable about a given home. It is to be appreciated that the house data stored in the house database 114 may be used in defining a daily pattern, identifying an exception to a daily pattern, and generating a response, which may include activation of one or more activators and providing points of contact and/or responders with related data.

Hub: Storage: Response Database 116

As discussed above, the storage device 110 may include a response database 116. The response database 116 may include data that may be used to control one or more activators and sensors, send a response message to points of contact and/or responders, and otherwise. For example and not by limitation, the response database 116 may include response data that can activate/deactivate alarm systems, enable/disable electrical circuits, switches, appliances, or the like, provide environmental and other sensor readings to points of contact and/or responders, or otherwise.

Hub: Interfaces 118/120/122/124

The hub 102 may include one or more hardware and software interfaces which facilitate the transfer of data, power and/or other signals by, between, to, from, as an intermediary, or otherwise between a hub 102 and one or more external devices. An interface may support use of one or more communications, networking, power, or other technologies, standards, protocols, and the like (herein, “technologies”). Interfaces are well known in the art and one non-limiting example includes network interface cards (“NICs”). NICs may be configured for example, and not by limitation, to support technologies including Wi-Fi, BLUETOOTH™, cellular, and otherwise. As shown in FIG. 1, multiple interfaces may be provided in a given hub 102. It is to be appreciated that such interfaces may be defined virtually with one or more commonly utilized technologies being used to support multiple interface features and/or functions. Non-limiting examples of interfaces include a hub to activator interface 118, a hub to sensor interface 120, a hub to user device interface 122, and a hub to network/telecom interface 124.

Hub: Bus 126

As shown in FIG. 1, a hub 102 may include a bus 126 or other data communication technology that is configured to facilitate the transfer of data, power, and the like between various components of the hub 102. The bus 126 may use any known or later arising technologies, and may arise within and/or external to the hub 102. Non-limiting examples of bus technologies include peripheral component interconnect (PCI), compute express link (CXL), industry standard architecture (ISA), expanded industry standard architecture (EISA), IEEE-1394, PC Card, Thunderbolt, Fieldbus, eSATA, and other technologies.

Activators 130

The system 100 may include one or more activators 130. As used herein, an activator 130 is any device that can be controlled by the hub 102. Non-limiting examples of activators include any Self-monitoring Analysis and Reporting Technology (“Smart”) device. Smart devices, which are often referred to as Smart Home technologies, include, for example and not by limitation, lighting control systems, thermostats, HVAC systems, home security systems, home alarm systems, home energy monitors, door locks, building automation, garden irrigation technologies, appliances, domestic robots, audio/video systems, home networks, Internet of Things (IoT) devices, artificial intelligence devices, and others. One or more activators 130 may be provided separate and/or in conjunction with one or more sensors 132.

For at least one implementation, an activator 130 may be configured to perform one or more tasks based upon a predetermined, then determined, artificial intelligence determined, or other criteria. For example, a garage door activator may be configured to close a garage door, if not already closed, within a given period from a car leaving the garage. Similarly, a front door lock activator may be configured to automatically lock and/or unlock a door at a given time. For example, at a given time at night, when a school aged child is returning home, when a guest is expected to arrive, when a package is to be delivered, or otherwise.

Sensors 132

The system 100 may include one or more sensors 132. The one or more sensors 132 may include SMART home sensors. Non-limiting examples of sensors include smoke and fire detectors, thermostats, motion detectors, sound detectors, light detectors, wind detectors, water detectors, electrical circuit monitors, cameras, microphones, and the like. Sensors 132 may be provide separate and/or in conjunction with activators 130.

For at least one implementation, the sensors 132 may include sensors configured for use with disabled persons. Non-limiting examples includes sensors 132 configured to read and/or present information using sign language, lip reading, language translations, and the like. Such information may originate and/or be presented in any medium including audible, visual, gesture based, or otherwise. Sensors may be provided for use with any handicap, disability, sensitivity, allergies, or otherwise. For example, odor/smell/taste/substance sensors may be provided for detecting hazardous gasses, such as CO2, radon, lead, arsenic, or otherwise.

For at least one implementation, a sensor 132 may be configured to generate sensor data based upon one or more predetermined, artificial intelligence determined, specified, or other conditions. For example, a motion sensor 132 may be configured to generate sensor data when an expected motion is not detected within a given period of time. For example, a user returning home not opening an interior door within a given period from parking their car in a garage. Sensors may be coupled together to determine whether deviations may exist. For example, a thermal sensor may be coupled with a motion sensor and used to detect a non-moving, heat generating object at a particular location.

Links 140/142/144/146/148

The system 100 may include one or more “links” which couple the hub 102 to one or more various external devices, at any given time. As used herein, a “link” may be configured to facilitate by, between, to or from, the hub 102 and one or more external devices the communication of data, providing of power, acting as a relay link between two or more of the hub 102 and an external device, and otherwise.

The hub 102 may be coupled to one or more activators 130 by activator links 140.

The hub 102 may be coupled to one or more sensors 132 by sensor links 142.

The hub 102 may be coupled to one or more user devices 160 by user device links 144.

The hub 102 may be coupled to one or more servers 152, points of contact devices 154, and/or responder devices 156 by network links 146 and/or telecom links 148.

A link may using any known or later arising technologies, standards, protocols, or otherwise (herein, “technologies”) which facilitate a providing of one or more features and a supporting of one or more functions. For example and not by limitation, a network link 146 may include use of Wide Area Networks (WAN), Cloud based networks, private networks, public networks, such as the Internet, and the like. Similarly and not by limitation, a telecom link 148 may include use of Public Switched Telephone Networks (PSTN), Plain Old Telephone Service (POTS), circuit switched networks, WANs, wireless communications technologies, such as 3G/4G/5G cellular, and the like.

The activator links 140, sensor links 142 and/or user device links 144 may utilize localized links such as those provided by Local Area Networks (LAN), BLUETOOTH™ near-field communications (NFC), Ethernet, fiber-optic, Wi-Fi, Internet of Things (IoT), Narrow-Band Internet of Things (NB-IoT), copper twisted pair cables, and others. It is to be appreciated that any given link may use one or more of any of technologies identified above and other known and/or later arising technologies. A link may use wired, wireless, and/or combinations of wired and wireless technologies. A link may use wireless technologies during certain operating periods, wired technologies during others, and combinations of wired and wireless technologies at any given time.

For at least one implementation, the telecom links 148 may utilize mid-band and/or high band 5G communications frequencies. As is commonly known and appreciated, mid-band 5G communications frequencies typically support communications of 100-400 Mb/s download and are typically deployed over 2.4 GHz to 4.2 GHz frequencies. Likewise, high band 5G communications frequencies typically support communications of 1-2 Gb/s download and are typically deployed over 24-72 GHz frequencies. For at least one implementation, one or more communications and networking standards and/or protocols may be used including the TCP/IP suite of protocols, the Extensible Message and Presence Protocol (XMPP), VOIP, Ethernet, Wi-Fi, CDMA, GSM/GRPS, TDMA/EDGE, EV/DO, WiMAX, SDR, LTE, MPEG, and others. It is to be appreciated that any selection of links may be combined or provided as single, multiple, or other combinations for at least one implementation. Accordingly, it is to be appreciated that the links are described herein for purposes of functional explanation and are not limited to any particular physical configurations.

Network Elements

The system 100 may include various network elements including, and not limited to, a network 150 such as a WAN, for example, the Internet, LAN, Cloud based networks, private networks, public networks, and otherwise. The network elements may also include one or more servers 152, non-limiting examples include web servers. Servers 152 may be configured to facilitate monitoring, detection, activation of activators, and alerting of others separately and/or in conjunction with a given hub 102. It is to be appreciated that one or more functions, features and/or capabilities of a hub 102 may be facilitated in whole or in part by one or more servers 152. As is well known, servers 152 typically include one or more processors configured to execute computer instructions. Such instructions may be facilitate the providing of one more features and/or functions of a given implementation of a system 100.

The network elements may also include one or more point of contact (POC) devices 154. POC devices 154 are generally referred to herein as any device, system, or component by which a designated one or more persons, a POC, may be notified by a hub 102, a server 152, a user device 160, a sensor 132, an activator 130, and/or a combination of the foregoing of current condition with respect to a monitored person, a monitored state of an area, a condition of a given activator 130, or otherwise. Non-limiting examples, of POC devices 154 may include telephones, smartphone, tablet devices, wearable devices such as smart watches, lap top computers, desktop computers, pagers, smart glasses, virtual reality glasses, augmented reality glasses, earbuds/headphones and other audible output devices, and the like.

The network elements may also include one or more responder devices 156. Responder devices 156 are generally referred to herein as any device, system, or component by which a designate one or more first responders, such as fire, police, ambulance, social workers, or others may be notified by a hub 102, a server 152, a user device 160, a sensor 132, an activator 130, and/or a combination of the foregoing of current condition with respect to a monitored person, a monitored state of an area, a condition of a given activator 130, or otherwise. Non-limiting examples, of responder devices 156 may include 911 dispatchers, radio system used by responders, telephones, smartphone, tablet devices, wearable devices such as smart watches, lap top computers, desktop computers, pagers, smart glasses, virtual reality glasses, augmented reality glasses, earbuds/headphones and other audible output devices, and the like.

User Device 160

As discussed above, the system 100 may include a user device 160. For at least one implementation, any known or later arising user device 160 may be used. Non-limiting examples of a user device 160 include smartphones, laptop computers, tablet computing devices, desktop computers, smart televisions, smart glasses, virtual reality glasses, augmented reality glasses, earbuds/headphones and other audible output devices, and other devices. The user device 160 may be communicatively coupled to one or more of the hub 102, servers 152, point of contact devices 154, responder devices 156, activators 130, and sensors 132 using any known or later arising communications and/or networking technologies.

User Device: Interface Module 162

As shown in FIG. 1, the user device 160 may include a user device interface module 162. The user device interface module 162 may communicatively couple the user device 160 to one or more of the hub 102, the activator links 140, the sensor links 142, the network links 146, and the telecom links 148. The user device 160 may output user data to the hub 102 and other elements.

User Device: Processor 164

The user device 160 may be configured to include a user device processor 164. The user device processor may be configured similarly to and/or have less, the same, or more of the capabilities of the processor 104, as described above. For purposes of conciseness, such capabilities are not repeated here. Any know or later arising CPU technologies may be used as the user device processor 164. The user device processor 164 may be communicatively coupled, by a user device bus 163 or similar structure, to other components of the user device 160

User Device: Storage Device 166

The user device 160 may be configured to include a user device storage device 166, which may also be referred to as a “computer readable storage medium.” Any known or later arising technology may be used for the user device storage device 166 including those described above with respect to the storage device 110 for the hub 102.

User Device: Input/Output Module 168

The user devices 160 may be further configured, for at least one implementation, to include a user device input/output module 168. The user devices input/output module 168 may include any known or later arising human to device interface components, processes, and technologies. Non-limiting examples of input/output uses include audible inputs (such as spoken commands) and outputs (generated sound), visible inputs (such as eye tracking and facial recognition) and outputs (such as visible images presented on a display device, LEDs, or otherwise), touch inputs touch feedback (such as vibrations or other movements), gesture tracking, and otherwise. The user device input/output module 168 may be coupled to and/or include the one or more presentation devices (not shown). The presentation devices facilitate interactions between a monitored person and a given user device 160.

For at least one implementation, a user device user input/output module 168 may be configured to include one or more of an audio input/output (I/O module, a visual I/O module, a text I/O module, a gesture I/O module and/or other interface modules. Various non-limiting features and functions of such I/O modules are described herein.

Audio I/O Module: Audio I/O modules may be configured to support the providing of audible signals between a monitored person and a user device. Such audio signals may include spoken text, sounds, or any other audible information. Such audible information may include one or more of humanly perceptible audio signals, where humanly perceptible audio signals typically arise between 20 Hz and 20 KHz. For at least one implementation, the range of humanly perceptible audio signals may be configurable to support an audible range of a given monitored person.

For at least one implementation, an audio I/O module generally includes hardware and computer instructions (herein, “audio technologies”) which supports the input and output of audible signals to a monitored person. Such audio technologies may include, and not limited to, noise cancelling, noise reduction, technologies for converting human speech to text, text to speech, translation from a first language to one or more second languages, playback rate adjustment, playback frequency adjustment, volume adjustments and otherwise. Non-limiting examples of audio technologies that may be utilized in an audio I/O module include GOOGLE VOICE, SFTRANSCRIPTION, BRIGHTSCRIPT, GOOGLE ASSISTANT, SIRI, and others.

In at least one implementation, an audio I/O module may be configured to use one or more microphones and speakers to capture and present audible information to a monitored person. Such one or more microphones and speakers may be provided by a given user device itself or by a device communicatively couple additional audible device component, for example, by earbuds may be communicatively coupled to a smartphone, with the earbuds functioning as an audio I/O module and capturing and presenting audio sounds to and from a monitored person, while the smartphone functions as a user device. Accordingly, it is to be appreciated that any existing or future arising audio I/O devices, systems and/or components may be utilized by and/or in conjunction with a user device to facilitate communications within an internal net and/or for communication over an external net.

Visual I/O Module: For at least one implementation, a user device 160 may include a visual I/O module configured to support the providing of visible signals to a monitored person. Such visible signals may be in any form, such as still images, motion images, augmented reality images, virtual reality images, and otherwise. Such visible information may include one or more of humanly perceptible visible signals. For at least one implementation, a visual I/O module may also be configured to capture non-humanly visible images, such as those arising in the X-ray, ultra-violet, infra-red or other spectrum ranges. Such non-humanly visible images may be converted into humanly visibly perceptible images by a user device.

For at least one implementation, a visual I/O module generally includes hardware and computer instructions (herein, “visible technologies”) which supports the input by and output of visible signals to point of contact devices 154, responder devices 156, the hub 102, and otherwise. Such visible technologies may include technologies for converting images (in any spectrum range) into humanly perceptible images, converting content of visible images into a given user's perceptible content, such as by character recognition, translation, playback rate adjustment, playback frequency adjustment, and otherwise.

A visual I/O module may be configured to use one or more display devices configured to present visible information to a monitored person. A visual I/O module may be configured to use one or more image capture devices, such as those provided by lenses, digital image capture and processing software and the like which may be provided by a given user device itself or by a communicatively coupled additional image capture device component, for example, a remote camera in a vehicle or otherwise. Accordingly, it is to be appreciated that any existing or future arising visual I/O devices, systems and/or components may be utilized by and/or in conjunction with a user device to facilitate the capture, communication and/or presentation of visual information.

Text I/O Module: For at least one implementation, a user device 160 may include a text I/O module configured to support the providing of textual information input by a monitored person. Such textual information signals may be in any language, format, character set, or otherwise. Such textual information may include one or more of humanly perceptible characters, such as letters of the alphabet or otherwise. For at least one implementation, a text I/O module may also be configured to capture textual information in first form, such as a first language, and convert such textual information into a second form, such as a second language.

A text I/O module generally includes hardware and computer instructions (herein, “textual technologies”) which supports the input by and output of textual information signals to a monitored person. In at least one implementation, a text T/O module may be configured to use an input device, such as a keyboard, touch pad, mouse, or other device to capture textual information. It is to be appreciated that any existing or future arising text I/O devices, systems and/or components may be utilized by and/or in conjunction with a user device 160 to facilitate the use of textual information.

Gesture I/O Module: For at least one implementation, a user device 160 may include a gesture I/O module configured to support the providing of gesture information, such as sign language, by a monitored person using a user device 160. Such gesture information signals may be in any form or format. Such gesture information may include one or more of humanly perceptible characters, such as those provided by sign language. For at least one implementation, a gesture I/O module may also be configured to capture a monitored person's motions to control one or more aspects of a user device, examples of such motions including those commonly used on smartphone touch interfaces.

A gesture I/O module generally includes hardware and computer instructions (herein, “gesture technologies”) which supports the input by and output of gesture information signals to a monitored person. Such gesture technologies may include technologies for inputting, outputting, and converting gesture content into any given form, such as into textual information, audible information, visual information, device instructions or otherwise. In at least one implementation, a gesture I/O module may be configured to use an input device, such as a motion detecting camera, touch pad, mouse, motion sensors, or other devices configured to capture motion information.

It is to be appreciated that any existing or future arising gesture I/O devices, systems and/or components may be utilized by and/or in conjunction with a user device 160.

User Device: Location Detector 170

For at least one implementation, a user device 160 may include a user device location detector 170. The user device location detector 170 may use any known or later arising location detection technologies, non-limiting examples include use of the Global Positioning Satellite system.

User Device: Motion Detector 172

For at least one implementation, a user device 160 may include a motion detector 172. The motion detector 172 may use any known or later arising motion detection technologies, non-limiting examples include accelerometers, gyroscopes, and the like.

User Device: Biometric Detector 174

For at least one implementation, a user device 160 may include a biometric detector 174. The biometric detector 174 may use any known or later arising technologies which facilitate monitoring of one or more biological indicators for a monitored persons; non-limiting examples including heart-rate monitors, sleep monitors, pulse oximeters, blood pressure monitors, temperature monitors, respiration monitors, perspiration monitors, and the like.

User Device: Environmental Detector 176

For at least one implementation, a user device 160 may include an environmental detector 176. The environmental detector 176 may use any known or later arising technologies which facilitate monitoring of one or more environmental conditions for a monitored persons; non-limiting examples including temperature monitors, barometric pressure monitors, solar intensity monitors, wind speed and direction monitors, and the like.

User Device: Power Module

The user device 160 may be further configured, for at least one implementation, to include a user device power module (not shown). The user device power module may include any known or later arising technologies which facilitate the use of electrical energy by a user device 160. Non-limiting examples of such technologies include batteries, power converters, inductive charging components, line-power components, solar power components, and otherwise.

User Device: Security Module

The user device 160 may be further configured, for at least one implementation, to include a user device security module (not shown). The user device security module may include any known or later arising security hardware components and/or computer instructions configured for use to secure user device processes and data, and otherwise. Security components may be used to facilitate secure transmission, processing, storage and otherwise of any data used in accordance with an implementation of the present disclosure.

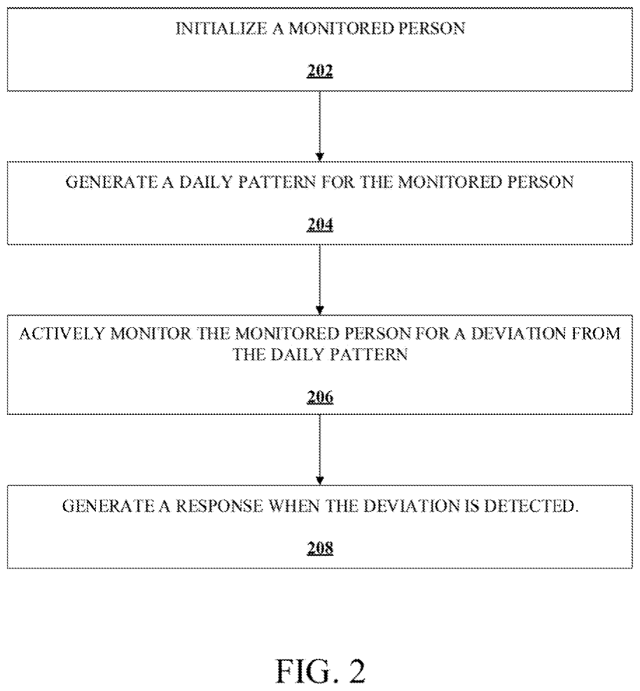

As shown in FIG. 2, a method for facilitating a smart home with artificial intelligence and in accordance with at least one implementation of the present disclosure may include (per Operation 202), an operation of initialize a monitored person. Initializing of a monitored person may include generating a user profile. As discussed above, information provided in a user profile database 112 may be used in generating the user profile. The user profile database 112 may be populated using data input by the monitored person, points of contact, and others. The user profile database 112 may include an indication of one or more user preferences. Information obtained from sources provided by network elements, such as medical databases, work databases, criminal databases, or otherwise may also be used in generating the user profile. The user profile may be generated using artificial intelligence, machine learning, and other known and later arising user profiling technologies.

Per Operation 204, the process may include generating a daily pattern for the monitored person. As discussed above, the daily pattern may be generated based on user profile data, parameters, or other information. The generating of the daily pattern may include generating patterns, which as discussed above may include multiple daily patterns.

Per Operation 206, the process may include actively monitoring a monitored person for a deviation from a daily pattern. Such active monitoring may occur using sensors, actions and inactions of the monitored person, based upon inputs received from others, such as points of contact, and otherwise.

Per Operation 208, the process may include generating a response when a deviation is detected. The response may include any action, non-limiting examples including activating (or deactivating, as the case may be) activators and/or sensors, notifying servers 152, points of contact devices 154 and/or responder devices 156, and the like. It is to be appreciated that a response to a given deviation may be generated automatically, such as by following a pre-determined response script or the like, dynamically, or otherwise. Artificial intelligence and/or machine learning technologies may be used in generating an ad hoc response. An ad hoc response may be one where a response to a given one or more deviations is not defined, has not been previously exercised, or otherwise.

For at least one implementation, one or more of Operations 202 to 208 may be implemented by a hub 102 operating in a stand-alone mode, for example, where the network link 146 and/or telecom link 148 is not available or operable. For other implementations, one or more of Operations 202 to 208 may be implemented by a hub 102 that is operating in a connected mode, such as in conjunction with, under the control of, or otherwise with respect to one or more network elements, such as server 152. It is to be appreciated that a stand-alone mode versus a connected mode of operation may be used for the hub 102 in view of one or more considerations, such as privacy levels and/or security levels for a given implementation. For example, a senior living facility may have a higher level of privacy consideration than a commercial establishment, while a prison may have a higher level of security consideration than a personal home.

It is to be appreciated that the operations described above and depicted in FIG. 2 are illustrative and are not intended herein to occur, for a given implementation of the present disclosure, in the order shown, in sequence, or otherwise. One or more operations may be performed in parallel and operations may be not performed, as provided for any given use of an implementation of the present disclosure.

Although various implementations of the claimed invention have been described above with a certain degree of particularity, or with reference to one or more individual implementations, those skilled in the art could make numerous alterations to the disclosed implementations without departing from the spirit or scope of the claimed invention. The use of the terms “approximately” or “substantially” means that a value of an element has a parameter that is expected to be close to a stated value or position. As is well known in the art, there may be minor variations that prevent the values from being exactly as stated. Accordingly, anticipated variances, such as 10% differences, are reasonable variances that a person having ordinary skill in the art would expect and know are acceptable relative to a stated or ideal goal for one or more implementations of the present disclosure. It is also to be appreciated that the terms “top” and “bottom”, “left” and “right”, “up” or “down”, “first”, “second”, “next”, “last”, “before”, “after”, and other similar terms are used for description and ease of reference purposes and are not intended to be limiting to any orientation or configuration of any elements or sequences of operations for the various implementations of the present disclosure. Further, the terms “coupled”, “connected” or otherwise are not intended to limit such interactions and communication of signals between two or more devices, systems, components or otherwise to direct interactions; indirect couplings and connections may also occur. Further, the terms “and” and “or” are not intended to be used in a limiting or expansive nature and cover any possible range of combinations of elements and operations of an implementation of the present disclosure. Other implementations are therefore contemplated. It is intended that matter contained in the above description and shown in the accompanying drawings shall be interpreted as illustrative of implementations and not limiting. Changes in detail or structure may be made without departing from the basic elements of the invention as defined in the following claims.

What is claimed is:

1. A system comprising:
an activator;
a sensor; and
a hub, coupled to the activator and to the sensor, comprising:
a hub processor configured to execute non-transient computer instructions for instantiating a patterns engine, an exceptions engine, and a response engine;
wherein the patterns engine further comprises first computer instructions which configure the hub to define a pattern for a monitored person and generate a pattern message that includes the pattern;
wherein the exceptions engine further comprises second computer instructions which configure the hub to monitor the monitored person for a deviation from the pattern defined in the pattern message, and when the deviation is identified, generate a deviation message;
wherein the response engine further comprises third computer instructions which configure the hub to generate, based on the deviation message, a response message; and
wherein the response message instructs the hub to activate as least one of the activator and the sensor.

2. The system of claim 1,
wherein the response message further instructs the hub to notify at least one of a point of contact and a responder of the pattern and the deviation from the pattern.

3. The system of claim 1,
wherein the activator is a Self-Monitoring Analysis and Reporting Technology (SMART) home device.

4. The system of claim 3,
wherein the sensor is a SMART home sensor.

5. The system of claim 1,
wherein the first computer instructions further configure the hub to define the pattern based upon at least one parameter.

6. The system of claim 5,
wherein the at least one parameter is obtained from at least one of a user input, the sensor, and a database;
wherein the user input is provided by at least one of the monitored person, a point of contact and a responder; and
wherein the database is at least one of a user profile database, a house database, a response database, and a network element database.

7. The system of claim 6,
wherein the pattern includes at least one daily pattern; and
wherein a daily pattern is a routine of the monitored person that is scheduled to occur on a given day, and at least one of at a given time and within a given time period.

8. The system of claim 1,
wherein the first computer instructions comprises instructions for instantiating an artificial intelligence process executed by hub processor; and
wherein the artificial intelligence process facilitates defining of a predicted future pattern for the monitored person based upon a currently active pattern and at least one of a prior daily pattern, a current event, a current activity, a future event, and a future activity.

9. The system of claim 8,
wherein the current event includes a weather event; and
wherein the artificial intelligence process updates the currently active pattern to reflect predicted conditions arising due the weather event.

10. The system of claim 1, further comprising:
a user device coupled to the hub;
wherein the user device comprises at least one detector;
wherein the at least one detector comprises at least one of a user location detector, a user motion detector, a user biometric detector, and a user environmental detector;
wherein the user device outputs, to the hub, user data generated by the at least one detector; and
wherein the exception engine identifies deviation based upon the user data received from the user device.

11. The system of claim 1, further comprising:
at least one network element coupled to the hub;
wherein the response engine communicates the response message to the at least one network element; and
wherein the response message identifies the pattern, the deviation from the pattern, and the activation of the at least one of the activator and the sensor.

12. The system of claim 11,
wherein the at least one network element further comprises at least one of a point of contact device associated with a designated point of contact person, and a responder device.

13. A hub comprising:
a hub processor configured to execute non-transient computer instructions for instantiating a patterns engine, an exceptions engine, and a response engine; and
a storage device 110, coupled to the hub processor, configured to store non-transient data in at least one of a user profile database, a house database, and a response database;
wherein the patterns engine further comprises first computer instructions which configure the hub to define a pattern for a monitored person and generate a pattern message that includes the pattern;
wherein the exceptions engine further comprises second computer instructions which configure the hub to monitor the monitored person for a deviation from the pattern defined in the pattern message, and when the deviation is identified, generate a deviation message;
wherein the response engine further comprises third computer instructions which configure the hub to generate, based on the deviation message, a response message; and
wherein the response message instructs the hub to activate as least one of an activator and a sensor.

14. The hub of claim 13, further comprising:
a hub to user device interface operable for receiving user data from a user device;
wherein the user data includes data provided by at least one of a user location detector, a user motion detector, a user biometric detector, and a user environmental detector; and
wherein the deviation is identified by exceptions engine based upon the user data received from the user device.

15. A method comprising:
initializing a monitored person;
generating a daily pattern for the monitored person;
actively monitoring the monitored person for a deviation from the daily pattern; and
generating a response when the deviation is detected.

16. The method of claim 15,
wherein the initializing of the monitored person further comprises:
first generating a user profile based upon data obtained from a user profile database associated with a hub device utilized in the actively monitoring of the monitored person; and
second generating a user profile based upon data obtained from at least one of a medical database, a work database, criminal database, and a database provided by a network element.

17. The method of claim 16,
wherein the user profile database includes at least one user preference.

18. The method of claim 17,
wherein the at least one user preference includes an advance medical directive.

19. The method of claim 15,
wherein the actively monitoring the monitored person for a deviation from the daily pattern further comprises:
receiving sensor data from a first sensor; and
determining whether the sensor data conforms with the daily pattern for a given time of a given day;
when the sensor data does not conform with the daily pattern,
generating a deviation message indicating the daily pattern and the deviation from the daily pattern; and
outputting the deviation message to a response engine being executed by a processor in a hub device.

20. The method of claim 19, further comprising:
by the response engine and in response to receiving the deviation message generating a response message;
wherein the response message identifies the daily pattern and the deviation;
wherein the response message activates at least one of an activator and a sensor; and
wherein the response message communicates the daily pattern and the deviation from the daily pattern to at least one of a point of contact device and a responder device.
